(19) United States
(12) Patent Application Publication
(10) Pub. No.: US 2002/0002768 A1
(43) Pub. Date: Jan. 10, 2002

(54) Method of protecting the inner thread of a blind rivet nut

(76) Inventor: Hermann Roser, Kommern (DE)

Correspondence Address: Edward D. Murphy, Esq., The Black & Decker Corporation, 701 East Joppa Road, Towson, MD, 21286, US

(21) Appl. No.: 09/883,487

(22) Filed: Jun. 18, 2001

(30) Foreign Application Priority Data
Jul. 5, 2000 (DE) 10032541.6

(51) Int. Cl. B23P 17/00

(52) U.S. Cl. 29/423

(57) ABSTRACT

The invention relates to a process for protecting an internal thread (7) of a blind rivet (2) during a second operation, such as painting or lacquering, wherein the internal thread (7) is provided with a mandrel (9) having a shank 12 with an external thread, which mandrel (9) is connected to the blind rivet (2) during riveting of the blind rivet (2) to a workpiece (1) and remains in the internal thread (7) during the second operation so as to protect the internal thread (7) from soiling during the workpiece (1) and the blind rivet (2) having its surface worked on, as by being painted.

### BACKGROUND OF THE INVENTION

The invention relates to a process for protecting an internal thread of a blind rivet during an operation, in particular painting.

Processes for protecting an internal thread of a blind rivet during an operation, in particular painting, are known in which the internal thread of the complete rivet is sealed by a stopper-type component in order to protect the internal thread from paint and lacquer particles. Protection of such an internal thread is necessary, as a blind rivet is not used exclusively for connecting workpieces but also for securing components to a workpiece by means of a blind rivet. In the known processes it is disadvantageous that a plurality of steps are necessary in order to protect the internal thread of the blind rivet effectively against soiling, in particular by paints or lacquers. This additional step of sealing the blind rivet by plugging or the like is time-consuming and as a result of the small size of blind rivets it is an activity which demands high precision, in particular if the setting of blind rivets is automated and therefore, in addition to the time-consuming activity, cost-intensive devices are also necessary in order to ensure reliable protection against soiling.

### SUMMARY OF THE PRESENT INVENTION

It is the object of the invention therefore to provide a process by which protection of the internal thread is ensured quickly and reliably after setting of the rivet.

This object is achieved according to the invention by a process for protecting an internal thread of a blind rivet during a second step, in particular painting, wherein the internal thread with a mandrel having an external thread, which mandrel is used for riveting the blind rivet to a workpiece during a first operation, remains in the internal thread during the second operation to protect the same from soiling.

In order to use the blind rivet to secure a component after the second operation, for example painting or sandblasting, it is expedient to unscrew the mandrel from the internal thread after this operation in order to finally secure a component to a workpiece during a third operation by means of the blind rivet. In this case it is particularly advantageous to also use the mandrel provided with an external thread to secure the component to the workpiece.

The blind rivet in accordance with U.S. Pat. No. 5,259,713 is particularly suitable for carrying out the process according to the invention as it has a mandrel with external thread which is advantageously provided with a head in which a screwdriver, for example, can engage. The blind rivet in accordance with U.S. Pat. No. 5,259,713 has also proved expedient as the mandrel is provided with a self-cutting external thread and therefore during the screwing in of the blind rivet into the rivet tube an internal thread is cut. This interlocking fit between mandrel and blind rivet on the one hand permits the introduction and exercising of the necessary tensile force to deform the rivet tube and ensures a reliable protection against soiling of the internal thread in a subsequent operation, for example painting or sandblasting. It is, however, also possible to use a mandrel which engages in an existing internal thread.

### BRIEF DESCRIPTION OF THE ACCOMPANYING DRAWINGS

For the purpose of explaining the invention an embodiment will be described below with the aid of the attached drawings, in which:

FIG. 1 shows a sectional view of the blind rivet after riveting;

FIG. 2 shows a sectional view of the blind rivet according to FIG. 1 after a second operation, for example painting;

FIG. 3 shows a sectional illustration of the blind rivet according to FIG. 1 after removal of the mandrel.

### DETAILED DESCRIPTION OF THE PREFERRED EMBODIMENT

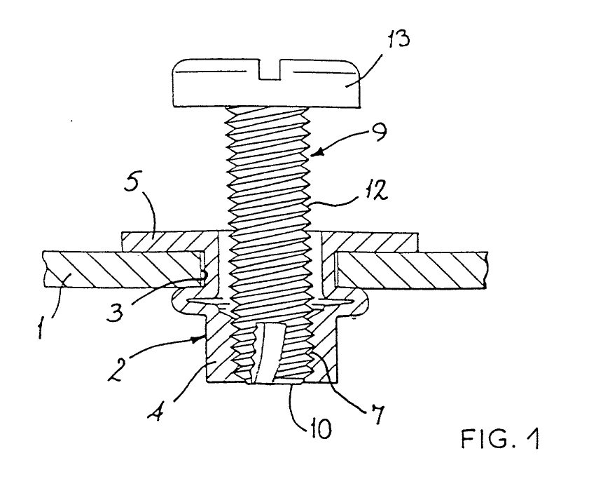

FIG. 1 shows a workpiece 1 which is preferably composed of a sheet metal plate in which a blind rivet 2 is inserted. A hole 3 is worked into the workpiece 1 to receive the blind rivet 2. The blind rivet 2 is composed of a rivet tube 4 and a flange 5 which rests on the workpiece 1. A mandrel 9 has a cutting slot which extends a short distance axially upwardly from the bottom 10 thereof, and an externally threaded shank 12 which terminates in a slotted head 13. By turning the mandrel 9 into the rivet tube 4 the internal thread 7 is cut and thus an interlocking fit is produced between mandrel and blind rivet 2. A known setting tool (not shown) is used for setting the blind rivet 2 so riveting, i.e. an interlocking fit is obtained between the blind rivet and the workpiece 1.

After this first operation the workpiece 1 is subjected to a second operation, for example painting or another kind of surface treatment such as sandblasting or the like for example.

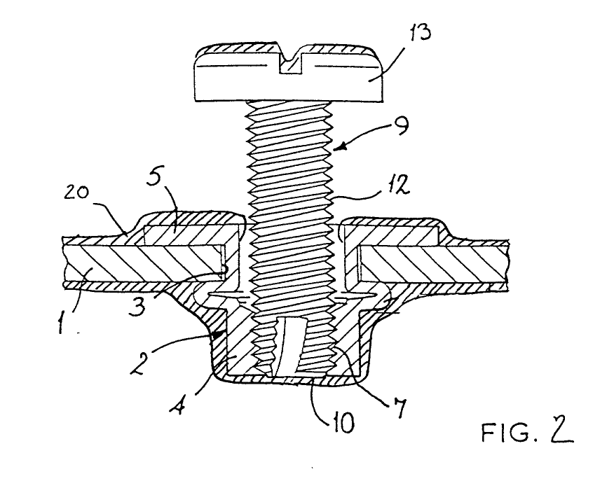

FIG. 2 shows the blind rivet in accordance with FIG. 1, a layer 20 composed of paint and/or lacquer having been applied to the workpiece 1. Whilst the workpiece 1 in FIG. 2 has been treated on both sides, a one-sided treatment, for example painting, is however also conceivable. In particular in the motor industry, one-sided surface painting of components and workpieces only is carried out, if a painting bath is not used.

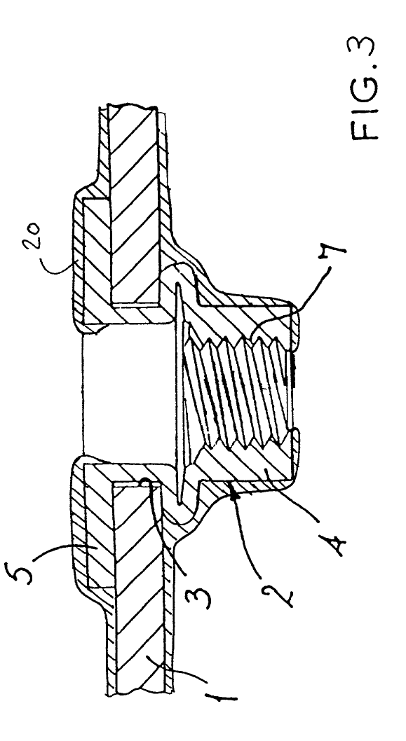

FIG. 3 shows the blind rivet 2 after removal of the mandrel 9, and it can clearly be seen that the lacquer layer 20 does not coat the thread 7 but merely adheres to the edges of the blind rivet 2. After removal of the mandrel 9, the mandrel 9 can be screwed into the blind rivet 2 again in conjunction with a securing component (not shown) to connect the component to the workpiece 1.

In general, the above identified embodiments are not to be construed as limiting the breadth of the present invention. It will be understood that modifications or other alternative constructions may become apparent within the scope of the invention as defined in the appended claims.

What is claimed is:

1. A process for protecting an internal thread (7) of a blind rivet (2) after the blind rivet has been connected to a workpiece comprising:
a. a mandrel (9) having an external thread (12), removably connected to the internal thread (7) of the blind rivet (2) prior to the blind rivet (2) being connected to the workpiece (1) to protect the internal threads (7) from soiling, whereby the workpiece and the blind rivet may have its surface worked on without contaminating the internal threads (7).

2. The process claimed in claim 1, wherein:
a. the mandrel (9) is unscrewed from the internal thread (7) of the blind rivet (2) after the blind rivet (2) has been worked on.

3. The process claimed in claim 2, wherein:
a. a component is secured to the workpiece (1) by the mandrel (9) which has been removed and reconnected to the blind rivet (2) after the workpiece (1) has been worked on.
